(19) United States
(12) Patent Application Publication
(10) Pub. No.: US 2020/0370667 A1
(43) Pub. Date: Nov. 26, 2020

(54) REFRIGERANT RELIEF VALVE MANIFOLD

(71) Applicant: Mueller Refrigeration, LLC, Hartsville, TN (US)

(72) Inventors: Mark Bornand, Gallatin, TN (US); Shi Xi Wei, Hendersonville, TN (US)

(73) Assignee: Mueller Refrigeration, LLC, Hartsville, TN (US)

(21) Appl. No.: 16/421,595

(22) Filed: May 24, 2019

(51) Int. Cl. F16K 11/087; F16K 27/06; F16K 5/06

(52) U.S. Cl. CPC F16K 11/0873; F16K 5/0605; F16K 27/067

(57) ABSTRACT

A refrigerant relief valve manifold includes a valve body assembly and a valve member. The valve body assembly defines a lower inlet and a plurality of upper outlets. The valve body assembly further defines a plurality of low pressure drop passages. Each valve body assembly low pressure drop passage extends between the lower inlet and an associated upper outlet. The valve member is movably disposed in the valve body assembly. The valve member defines a plurality of low pressure drop passages. The valve body assembly further includes a plurality of true mountings. Each valve body assembly true mounting defining one the upper outlet. Each valve body assembly true mounting is structured to be coupled to a coupled element such as, but not limited to, a relief valve.

### BACKGROUND OF THE INVENTION

### Field of the Invention

The present disclosure relates in general to refrigerant valves and, more specifically, to multiple outlet refrigerant valves wherein each outlet is defined by a true mounting.

### Background Information

A refrigerant system includes portions that operate at different pressures. The pressure in each portion is higher than atmospheric pressure. Further, refrigerant fluid is harmful to humans and/or the environment. For these reasons, the refrigerant system must be a closed system. A closed system, or a portion thereof, may become over pressurized. As such, refrigerant systems include one or more relief valves, i.e., valves that are structured to open automatically when the pressure reaches a dangerous level.

When an over-pressure event occurs, the relief valve opens, releases some refrigerant fluid, and closes. The relief valve must then be replaced. In a configuration wherein there is a single relief valve, the refrigerant system must be shut off so that the relief valve, i.e., the portion of the refrigerant system including the relief valve, can be isolated when the relief valve is removed. Alternatively, if the portion of the refrigerant system including the relief valve cannot be isolated, the entire refrigerant system must be evacuated.

To overcome this disadvantage, refrigerant systems include a relief valve manifold having more than one relief valve. In such a system, one of the plurality of relief valves is active, i.e., one relief valve is in fluid communication with the refrigerant system during use while the other relief valve(s) are isolated from the refrigerant system. When an over pressure event occurs, the active relief valve operates as described above and must be replaced. To do this, the manifold valves on the relief valve manifold are adjusted so that the used relief valve (the one that was active) is no longer in fluid communication with the refrigerant system. Further, a formerly non-active relief valve becomes the active relief valve. Then, the used relief valve is replaced. Thus, the refrigerant system does not have to be shut down and/or evacuated.

Further, in common practice, and in many instances by law or regulations, see e.g., ASME BPVC.VIII.1-2017, relief valves must be installed in an upright/vertical orientation. Further, the relief valve(s) must be disposed at, or near, the top of the refrigerant system. Thus, a relief valve manifold typically includes a lower coupling, a generally horizontal chamber or conduit and multiple upper couplings. The lower coupling is coupled to, and is in fluid communication with, the refrigerant system. The relief valves are coupled to the upper couplings. The horizontal chamber provides fluid communication between the lower coupling and the upper couplings. The problem with this configuration is that the fluid flow path includes multiple right angle turns. That is, fluid moves vertically through the lower coupling, then horizontally through the horizontal chamber, then vertically through the relief valve. This configuration has a disadvantageous pressure drop due to the fluid flow path. The problem with the pressure drop in the relief valve manifold was solved as set forth in U.S. Patent Publication 2007/0068584 wherein a Y-manifold valve was disclosed. The Y-shaped manifold did not have any turns in the fluid flow path that were greater than ninety degrees. The problem with this relief valve manifold, however, is that the upper branches of the Y-shaped valve are not structured to support the relief valves in an upright/vertical orientation. This is a problem.

There is, therefore, a need for a refrigerant relief valve manifold that provides a low pressure drop as well as a mounting structured to support relief valve(s) in an upright/vertical orientation. There is a further need for such a refrigerant relief valve manifold to be compatible with existing refrigerant systems.

### SUMMARY OF THE INVENTION

These needs, and others, are met by at least one embodiment of the disclosed and claimed concept which provides a refrigerant relief valve manifold including a valve body assembly and a valve member. The valve body assembly defines a lower inlet and a plurality of upper outlets. The valve body assembly further defines a plurality of low pressure drop passages. Each valve body assembly low pressure drop passage extends between the lower inlet and an associated upper outlet. The valve member is movably disposed in the valve body assembly. The valve member defines a plurality of low pressure drop passages. The valve body assembly further includes a plurality of true mountings. Each valve body assembly true mounting defining one the upper outlet. Each valve body assembly true mounting is structured to be coupled to a coupled element such as, but not limited to, a relief valve. A refrigerant system including such a refrigerant relief valve manifold is also provided.

### BRIEF DESCRIPTION OF THE DRAWINGS

A full understanding of the invention can be gained from the following description of the preferred embodiments when read in conjunction with the accompanying drawings in which:

FIG. 1 is a partially schematic, cross-sectional view of a refrigerant system with a refrigerant relief valve manifold.

FIG. 2 is an isometric view of a refrigerant relief valve manifold.

FIG. 3 is a cross-sectional view of another embodiment of a refrigerant relief valve manifold.

### DESCRIPTION OF THE PREFERRED EMBODIMENTS

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein. It is noted that the orientation and the location of the relief valves 19, discussed below, are significant and, as such, so are the directional phrases recited in the claims used to describe the positions and/or orientations of the inlet(s) 42, outlet(s) 44, 46 and other elements.

As used herein, the singular form of “a,” “an, ” and “the” include plural references unless the context clearly dictates otherwise. As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb. Thus, an element that is merely capable of performing the identified verb but which is not intended to, and is not designed to, perform the identified verb is not “structured to [verb].”

As used herein, “associated” means that the elements are part of the same assembly and/or operate together, or, act upon/with each other in some manner. For example, an automobile has four tires and four hubcaps. While all the elements are coupled as part of the automobile, it is understood that each hubcap is “associated” with a specific tire.

As used herein, a “coupling assembly” includes two or more couplings or coupling components. The components of a coupling or coupling assembly are generally not part of the same element or other component. As such, the components of a “coupling assembly” may not be described at the same time in the following description.

As used herein, a “coupling” or “coupling component(s)” is one or more component(s) of a coupling assembly. That is, a coupling assembly includes at least two components that are structured to be coupled together. It is understood that the components of a coupling assembly are compatible with each other. For example, in a coupling assembly, if one coupling component is a snap socket, the other coupling component is a snap plug, or, if one coupling component is a bolt, then the other coupling component is a nut or threaded bore.

As used herein, a “fastener” is a separate component structured to couple two or more elements. Thus, for example, a bolt is a “fastener” but a tongue-and-groove coupling is not a “fastener.” That is, the tongue-and-groove elements are part of the elements being coupled and are not a separate component.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the phrase “removably coupled” or “temporarily coupled” means that one component is coupled with another component in an essentially temporary manner. That is, the two components are coupled in such a way that the joining or separation of the components is easy and would not damage the components. For example, two components secured to each other with a limited number of readily accessible fasteners, i.e., fasteners that are not difficult to access, are “removably coupled” whereas two components that are welded together or joined by difficult to access fasteners are not “removably coupled.” A “difficult to access fastener” is one that requires the removal of one or more other components prior to accessing the fastener wherein the “other component” is not an access device such as, but not limited to, a door.

As used herein, “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true. With regard to electronic devices, a first electronic device is “operatively coupled” to a second electronic device when the first electronic device is structured to, and does, send a signal or current to the second electronic device causing the second electronic device to actuate or otherwise become powered or active.

As used herein, “temporarily disposed” means that a first element(s) or assembly(ies) is resting on a second element(s) or assembly(ies) in a manner that allows the first element/assembly to be moved without having to decouple or otherwise manipulate the first element. For example, a book simply resting on a table, i.e., the book is not glued or fastened to the table, is “temporarily disposed” on the table.

As used herein, the statement that two or more parts or components “engage” one another means that the elements exert a force or bias against one another either directly or through one or more intermediate elements or components. Further, as used herein with regard to moving parts, a moving part may “engage” another element during the motion from one position to another and/or may “engage” another element once in the described position. Thus, it is understood that the statements, “when element A moves to element A first position, element A engages element B,” and “when element A is in element A first position, element A engages element B” are equivalent statements and mean that element A either engages element B while moving to element A first position and/or element A engages element B while in element A first position.

As used herein, “operatively engage” means “engage and move.” That is, “operatively engage” when used in relation to a first component that is structured to move a movable or rotatable second component means that the first component applies a force sufficient to cause the second component to move. For example, a screwdriver may be placed into contact with a screw. When no force is applied to the screwdriver, the screwdriver is merely “temporarily coupled” to the screw. If an axial force is applied to the screwdriver, the screwdriver is pressed against the screw and “engages” the screw. However, when a rotational force is applied to the screwdriver, the screwdriver “operatively engages” the screw and causes the screw to rotate. Further, with electronic components, “operatively engage” means that one component controls another component by a control signal or current.

As used herein, in the phrase “[x] moves between its first position and second position,” or, “[y] is structured to move [x] between its first position and second position,” “[x]” is the name of an element or assembly. Further, when [x] is an element or assembly that moves between a number of positions, the pronoun “its” means “[x],” i.e., the named element or assembly that precedes the pronoun “its.”

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours. With regard to elements/assemblies that are movable or configurable, “corresponding” means that when elements/assemblies are related and that as one element/assembly is moved/reconfigured, then the other element/assembly is also moved/reconfigured in a predetermined manner. For example, a lever including a central fulcrum and elongated board, i.e., a “see-saw” or “teeter-totter,” the board has a first end and a second end. When the board first end is in a raised position, the board second end is in a lowered position. When the board first end is moved to a lowered position, the board second end moves to a “corresponding” raised position. Alternately, a cam shaft in an engine has a first lobe operatively coupled to a first piston. When the first lobe moves to its upward position, the first piston moves to a “corresponding” upper position, and, when the first lobe moves to a lower position, the first piston, moves to a “corresponding” lower position.

As used herein, a “path of travel” or “path,” when used in association with an element that moves, includes the space an element moves through when in motion. As such, any element that moves inherently has a “path of travel” or “path.” Further, a “path of travel” or “path” relates to a motion of one identifiable construct as a whole relative to another object. For example, assuming a perfectly smooth road, a rotating wheel (an identifiable construct) on an automobile generally does not move relative to the body (another object) of the automobile. That is, the wheel, as a whole, does not change its position relative to, for example, the adjacent fender. Thus, a rotating wheel does not have a “path of travel” or “path” relative to the body of the automobile. Conversely, the air inlet valve on that wheel (an identifiable construct) does have a “path of travel” or “path” relative to the body of the automobile. That is, while the wheel rotates and is in motion, the air inlet valve, as a whole, moves relative to the body of the automobile.

As used herein, the word “unitary” means a component that is created as a single piece or unit. That is, a component that includes pieces that are created separately and then coupled together as a unit is not a “unitary” component or body.

As used herein, “unified” means that all the elements of an assembly are disposed in a single location and/or within a single housing, frame or similar construct.

As used herein, the term “number” shall mean one or an integer greater than one (i.e., a plurality). That is, for example, the phrase “a number of elements” means one element or a plurality of elements. It is specifically noted that the term “a ‘number’ of [X]” includes a single [X].

As used herein, a “radial side/surface” for a circular or cylindrical body is a side/surface that extends about, or encircles, the center thereof or a height line passing through the center thereof. As used herein, an “axial side/surface” for a circular or cylindrical body is a side that extends in a plane extending generally perpendicular to a height line passing through the center. That is, generally, for a cylindrical soup can, the “radial side/surface” is the generally circular sidewall and the “axial side(s)/surface(s)” are the top and bottom of the soup can. Further, as used herein, “radially extending” means extending in a radial direction or along a radial line. That is, for example, a “radially extending” line extends from the center of the circle or cylinder toward the radial side/surface. Further, as used herein, “axially extending” means extending in the axial direction or along an axial line. That is, for example, an “axially extending” tine extends from the bottom of a cylinder toward the top of the cylinder and substantially parallel to, or along, a central longitudinal axis of the cylinder.

As used herein, “generally curvilinear” includes elements having multiple curved portions, combinations of curved portions and planar portions, and a plurality of linear/planar portions or segments disposed at angles relative to each other thereby forming a curve. As used herein, an “elongated” element inherently includes a longitudinal axis and/or longitudinal line extending in the direction of the elongation,

As used herein, “about” in a phrase such as “disposed about [an element, point or axis]” or “extend about [an element, point or axis]” or “[X] degrees about an [an element, point or axis],” means encircle, extend around, or measured around. When used in reference to a measurement or in a similar manner, “about” means “approximately,” i.e., in an approximate range relevant to the measurement as would be understood by one of ordinary skill in the art.

As used herein, “generally” means “in a general manner” relevant to the term being modified as would be understood by one of ordinary skill in the art. As used herein, “substantially” means “by a large amount or degree” relevant to the term being modified as would be understood by one of ordinary skill in the art.

As used herein, “at” means on and/or near relevant to the term being modified as would be understood by one of ordinary skill in the art.

As is known in the art, refrigerant systems are specialized. As such, and as used herein, any construct modified by the adjective “refrigerant” expressly excludes non-refrigerant constructs such as, but not limited to, water system constructs.

As used herein, a “low pressure drop passage” means a passage that is part of a refrigerant fluid system including two or more generally straight portions wherein the centerlines of any two contiguous passage portions do not define an angle greater than ninety degrees at the interface of the contiguous passage portions. That is, the passage does not include any bends or junctures having an angle greater than ninety degrees. It is noted that a Y-shaped manifold for a water hose cannot define a “low pressure drop passage” as such a construct is not part of a refrigerant fluid system.

As used herein, a “vertical low pressure drop passage” means a passage that is part of a refrigerant fluid system wherein the passage is a “low pressure drop passage” as defined above and wherein the passage inlet is structured to be disposed below the passage outlet. It is understood that all passages inherently have an inlet and an outlet. Further, to be a “vertical low pressure drop passage” as used herein, the construct defining the “vertical low pressure drop passage” must be structured to be oriented so that the passage inlet is disposed below the passage outlet. It is noted that a valve or manifold that is merely “capable” of being oriented with an inlet disposed below an outlet does not have the passage inlet “'structured' to be disposed” below the passage outlet (as “structured” is defined above).

As used herein, a “true” mounting means a mounting that is structured to support, and/or be coupled to, another non-adjustable construct wherein the other construct is disposed in either a substantially horizontal orientation or a substantially vertical orientation. As used herein, a construct is in either a “substantially horizontal orientation” or a “substantially vertical orientation” when a longitudinal axis or centerline of the construct extends substantially horizontally or substantially vertically. For example, a substantially horizontal table surface is a “true” mounting as it is structured to support a common 12 ounce aluminum beverage can resting on an axial end with the can longitudinal axis extending substantially vertically, and/or, is structured to support a pencil on a radial surface with the pencil longitudinal axis extending substantially horizontally. That is, a beverage can and a pencil are non-adjustable constructs, i.e., they cannot be reconfigured to rest on the table in a different manner, and the table surface supports the can/pencil with the longitudinal axis extending substantially vertically/horizontally. The possibility that an adjustable construct such as, but not limited to, a flexible gooseneck microphone, can be coupled to a mounting and configured to be in either a substantially horizontal orientation or a substantially vertical orientation does not convert a non-“true” mounting into a “true” mounting.

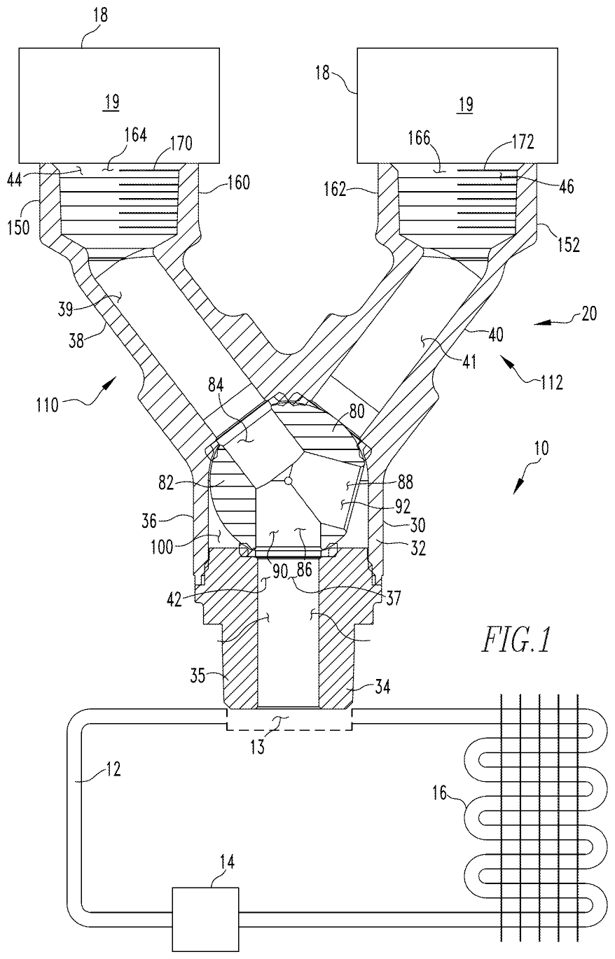

As shown in FIG. 1, a refrigerant system 10 includes a number of conduits 12 and a refrigerant relief valve manifold 20. The refrigerant system 10 also includes well known elements such as, but not limited to, a condenser 14 and an evaporator 16 which are not relevant to the present disclosure. Further, as used herein, a “conduit” includes any enclosed space such as a chamber defined by a housing as well as elongated constructs such as, but not limited to, a hose. Each conduit 12 defines a refrigerant fluid passage 13.

The refrigerant relief valve manifold 20 is disposed near the top of the refrigerant system 10. The refrigerant relief valve manifold 20 is sealingly coupled or sealingly directly coupled to one conduits 12. The refrigerant relief valve manifold 20 is structured to be, and is, coupled or directly coupled to a number of coupled elements 18 such as, but not limited to, relief valves 19. As used herein, a “coupled element” means a construct that is structured to be coupled to, and in fluid communication with, a refrigerant relief valve manifold. Accordingly, in this configuration, the coupled elements 18, i.e., relief valves 19, are disposed at or near the top of the refrigerant system 10.

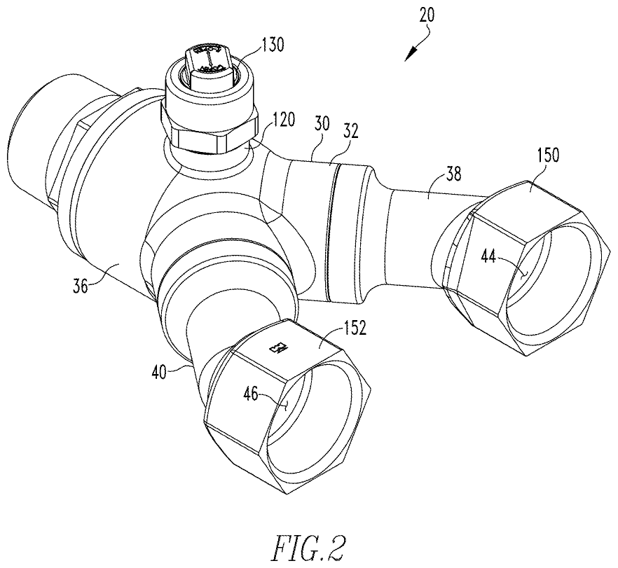

As shown in FIGS. 1 and 2, the refrigerant relief valve manifold 20 includes a valve body assembly 30 and a valve member 80. In the embodiment shown, the valve body assembly 30 is generally Y-shaped. As used herein, a “Y-shaped” construct inherently has a generally vertical, lower branch and two angled upper branches. Each branch is generally straight, elongated, and has a centerline. The three branches meet at a vertex which is the point whereat the three centerlines converge.

In one embodiment, the refrigerant relief valve manifold valve body assembly 30 (hereinafter, and as used herein, the “valve body assembly” 30) includes a unitary, substantially Y-shaped body 32 and a lower coupling 34. As noted in the definition, the valve body assembly Y-shaped body 32 includes a lower branch 36 and two upper branches 38, 40; also identified herein as valve body assembly first branch 38 and valve body assembly second branch 40. As noted above, the orientation of the valve body assembly 30 is significant and the lower branch 36 extends generally, or substantially, vertically. The upper branches 38, 40 are angled relative to the vertical axis of the lower branch 36. In an exemplary embodiment, the upper branches 38, 40 are angled between about 23° and 48°, or about 37.5° from vertical. Further, each branch 36, 38, 40 is generally hollow and defines an associated passage, i.e., a valve body assembly primary passage 37, a valve body assembly first passage 39, and a valve body assembly second passage 41. Thus, the valve body assembly 30 defines a lower inlet 42 and a plurality (two as shown) of upper outlets 44, 46; also identified herein as valve body assembly first outlet 44 and valve body assembly second outlet 46. The valve body assembly inlet 42 is in fluid communication with the primary passage 37. The valve body assembly first outlet 44 is in fluid communication with the valve body assembly first passage 39. The valve body assembly second outlet 46 is in fluid communication with the valve body assembly second passage 41. Further, the valve body assembly 30 defines a valve member chamber 100 discussed below.

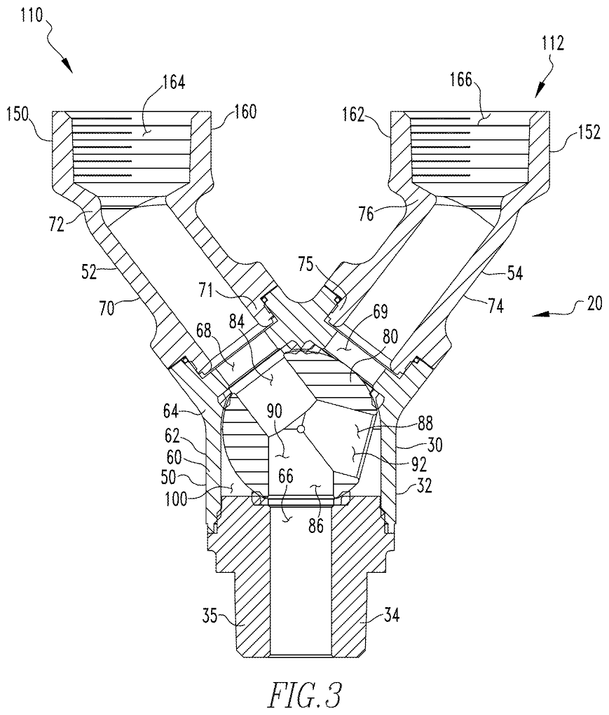

In another exemplary embodiment, shown in FIG. 3, the valve body assembly 30 includes a base element 50, the lower coupling 34 (as before), a first branch member 52 and a second branch member 54. In this embodiment, the valve body assembly base element 50 includes a body 60 with a generally toroid, lower portion 62 and an upper portion 64. The valve body assembly base element lower portion 62 defines a valve member chamber 100, discussed below, as well as a lower, primary opening 66 which, as shown, is coextensive with the lower inlet 42. The valve body assembly base element upper portion 64 defines a first opening 68 and a second opening 69. Each of the valve body assembly base element upper portion first and second opening 68, 69 is in fluid communication with the valve body assembly base element lower portion valve member chamber 100. Thus, the valve body assembly base element lower portion 62 (or the valve body assembly base element 50) defines a valve body assembly primary passage 37 as discussed above.

In an exemplary embodiment, the centerline of each valve body assembly base element upper portion first and second opening 68, 69 extends at an angle relative to a centerline of the valve body assembly base element lower portion primary opening 66. That is, as used herein, the “centerline” of an opening extends generally normal to a plane defined by that opening. As shown, the angle between the centerline of each valve body assembly base element upper portion first and second opening 68, 69 and the centerline of the valve body assembly base element lower portion primary opening 66 is between about 23° and 48°, or about 37.5°.

The valve body assembly first branch member 52 and the valve body assembly second branch member 54 each include an elongated, hollow body 70, 74 having a first end 71, 75 and a second end 72, 76. Thus, each valve body assembly branch member 52, 54 defines a passage 39, 41, as discussed above.

In this embodiment, the valve body assembly 30 is assembled as follows. Each branch member body first end 72, 76 is sealingly coupled to an associated valve body assembly base element upper portion first and second opening 68, 69. In an exemplary embodiment, each branch member body first end 72, 76 is brazed to the valve body assembly base element upper portion 64. Further, as shown, a seal (not numbered) is disposed between each valve body assembly branch member 52, 54 and the valve body assembly base element upper portion 64. The coupling of the valve body assembly branch members 52, 54 and the valve body assembly base element lower portion 62 creates a generally Y-shaped body.

In an exemplary embodiment, the lower coupling 34 includes a generally toroid body 35 that is structured to be, and is, coupled, directly coupled, or fixed to, or partially within, the valve body assembly lower inlet 42. For example, a portion of the lower coupling body has an outer diameter that corresponds to the valve body assembly lower inlet 42.

The refrigerant relief valve manifold valve member 80 (hereinafter, and as used herein, “valve member” 80) includes, in an exemplary embodiment, a generally spherical body 82 defining a primary outlet 84, a first inlet 86 and a second inlet 88 as well as a low pressure drop first passage 90 and a low pressure drop second passage 92. It is understood that the valve member body 82 includes a single outlet and a number of inlets corresponding to the number of outlets of the valve body assembly 30 which, as shown in this embodiment, is two. That is, the valve member body low pressure drop first passage 90 extends between the valve member body primary outlet 84 and the valve member body first inlet 86. The valve member body low pressure drop second passage 92 extends between the valve member body primary outlet 84 and the valve member body second inlet 88. Thus, as used herein, different/separate identified “passages,” in certain embodiments, share elements or portions. That is, the valve member body 82 defines a primary passage portion, a first passage portion, and a second passage portion (none numbered). The valve member body low pressure drop first passage 90 includes the primary passage portion and the first passage portion. The valve member body low pressure drop second passage 92 includes the primary passage portion and the second passage portion. Thus, the primary passage portion is, as used herein, part of both the valve member body low pressure drop first passage 90 and the valve member body low pressure drop second passage 92.

In both the unitary embodiment of the valve body assembly 30 and the non-unitary embodiment of the valve body assembly 30, the valve member chamber 100 is structured to have the valve member 80 sealingly disposed therein. Accordingly, in an embodiment wherein the valve member 80 is generally spherical, the valve member chamber 100 is a generally spherical chamber. The valve body assembly 30 includes a number of seals (none numbered) that are structured to be, and are, disposed between the valve member 80 and the valve body assembly 30. The valve member 80 is movably disposed in the valve member chamber 100. The lower coupling 34 is then coupled to the valve body assembly lower inlet 42 thereby trapping the valve member 80 in the valve member chamber 100. In this configuration, the passage defined by the lower coupling 34 is coextensive with the valve body assembly lower inlet 42 and is, as used herein, the valve body assembly lower inlet 42.

The valve body assembly 30 further includes a stem boss 120 and a seal cap assembly 130 as discussed in U.S. Patent Publication 2007/0068584. That is, the portion of U.S. Patent Publication 2007/0068584 discussing the stem boss and a seal cap assembly, as well as the portions discussing how the valve member 80 (or the “ball”) interact therewith, are incorporated by reference. That is, the valve member 80 is actuated as set forth in U.S. Patent Publication 2007/0068584.

In this configuration, the valve member 80 is structured to be, and is, movable between a first open position, wherein the valve member 80 provides fluid communication between the valve body assembly inlet 42 and the valve body assembly first outlet 44, and, a second position wherein said member provides fluid communication between the valve body assembly inlet 42 and the valve body assembly second outlet 46. That is, the valve member 80 moves between a first position, wherein the valve member body first inlet 86 is generally aligned with, and is in fluid communication with, the valve body assembly lower inlet 42 (and/or the valve body assembly primary passage 37), and, the valve member body primary outlet 84 is aligned with, and is in fluid communication with, the valve body assembly first passage 39 (and therefore is in fluid communication with the valve body assembly first outlet 44), and, a second position, wherein the valve member body second inlet 88 is generally aligned with, and is in fluid communication with, the valve body assembly lower inlet 42 (and/or the valve body assembly primary passage 37), and, the valve member body primary outlet 84 is aligned with, and is in fluid communication with, the valve body assembly second passage 41 (and therefore is in fluid communication with the valve body assembly second outlet 46). It is understood that, in an embodiment with more than two valve body assembly outlets, the valve member 80 is structured to move between a number of open positions wherein in each open position the valve member 80 provides fluid communication between the valve body assembly inlet 42 and a single valve body assembly upper outlet.

In this configuration, the valve body assembly 30 is structured to, and does, define a plurality of low pressure drop passages 110, 112. Each low pressure drop passage 110, 112 extends between the valve body assembly lower inlet 42 and an associated valve body assembly outlet 44, 46. That is, a low pressure drop first passage 110 includes the valve body assembly primary passage 37 and the valve body assembly first passage 39; thus, the low pressure drop first passage 110 extends between the valve body assembly lower inlet 42 and the valve body assembly first outlet 44. Further, a low pressure drop second passage 112 includes the valve body assembly primary passage 37 and the valve body assembly second passage 41; thus, the low pressure drop second passage 112 extends between the valve body assembly lower inlet 42 and the valve body assembly second outlet 46. Thus, the lower branch 36 defines a portion of both low pressure drop passages 110, 112. It is understood that only one of the valve body assembly low pressure drop passages 110, 112 is open at one time based on the position of the valve member 80. Further, as the valve body assembly 30 is structured to be, and is, oriented vertically, as described above, the valve body assembly low pressure drop passages 110, 112 are each “vertical” low pressure drop passages 110, 112.

The valve body assembly 30 includes a plurality of true mountings; two shown as a first true mounting 150 and a second true mounting 152. In an exemplary embodiment, each true mounting 150, 152 defines one of the valve body assembly outlets 44, 46. In this exemplary embodiment, each valve body assembly true mounting 150, 152 includes a collar, i.e., a first collar 160 and a second collar 162. As used herein, a “collar” means a generally torpid construct that inherently has an inner radial surface and an outer radial surface. Unlike a torus, however, a “collar” selectively includes a radial surface that is not generated by rotating a surface about an axis. In an exemplary embodiment, a collar includes a generally circular inner radial surface and a non-circular outer radial surface. Each valve body assembly true mounting collar 160, 162 defines a passage, i.e., a first collar passage 164 and a second collar passage 166. Each collar passage 164, 166 is generally shorter than the associated valve body assembly first passage 39 and valve body assembly second passage 41, respectively. The centerline of the valve body assembly true mounting collar passages 164, 166 are angled between about 23° and 48°, or about 37.5°, relative to the associated valve body assembly first passage 39 or valve body assembly second passage 41, respectively. Stated alternately, the centerline of each collar passage 164, 166 is generally, or substantially, parallel to the centerline of the valve body assembly primary passage 37. In this configuration, each collar passage 164, 166 is part of an associated valve body assembly low pressure drop passage 110, 112. That is, the valve body assembly 30 defines a low pressure drop first passage 110 and a low pressure drop second passage 112. The low pressure drop first passage 110 extends between, and provides fluid communication between, the valve body assembly lower inlet 42 and the valve body assembly first outlet 44 and includes the valve body assembly primary passage 37, the valve body assembly first passage 39 and the first collar passage 164. The low pressure drop second passage 112 extends between, and provides fluid communication between, the valve body assembly lower inlet 42 and the valve body assembly second outlet 46 and includes the valve body assembly primary passage 37, the valve body assembly second passage 41 and the second collar passage 166.

Further, in an exemplary embodiment, each collar 160, 162 (i.e., each true mounting 150. 152) is structured to be, and is, coupled to a coupled element (shown schematically). As used herein, a “coupled element” means a construct that is structured to be coupled to a refrigerant relief valve manifold 20 such as, but not limited to, a relief valve 19. In an exemplary embodiment, each collar 160, 162 includes internal threads 170, 172. Further, in an exemplary embodiment, an outer radial surface of each collar 160, 162 has a non-circular cross-section. For example, the outer radial surface of each collar 160, 162 is shown as being generally hexagonal.

In this configuration, the refrigerant relief valve manifold 20 is structured to have a low pressure drop therethrough and to support a coupled element in one of a generally (or substantially) vertical or horizontal orientation. This solves the problems noted above.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A refrigerant relief valve manifold comprising:
a valve body assembly defining a lower inlet and a plurality of upper outlets;
said valve body assembly defining a plurality of low pressure drop passages;
each valve body assembly low pressure drop passage extending between said valve body assembly lower inlet and an associated valve body assembly upper outlet;
a valve member movably disposed in said valve body assembly;
said valve member defining a plurality of low pressure drop passages;
said valve body assembly including a plurality of true mountings;
each valve body assembly true mounting defining one said upper outlet; and
each said valve body assembly true mounting structured to be coupled to a coupled element.

1. A refrigerant relief valve manifold of claim 1 wherein each low pressure drop passage is a vertical low pressure drop passage.

3. The refrigerant relief valve manifold of claim 1 wherein:
each said valve body assembly true mounting includes a collar; and
each said valve body assembly true mounting collar including internal threads.

4. The refrigerant relief valve manifold of claim 3 wherein:
each said valve body assembly true mounting collar includes an outer radial surface; and
wherein each said valve body assembly true mounting collar outer radial surface is non-circular.

5. The refrigerant relief valve manifold of claim 1 wherein:
said valve body assembly includes a base element;
said valve body assembly base element defining a valve member chamber;
said valve member movably disposed in said valve body assembly base valve member chamber;
said valve member including a single outlet and a number of inlets corresponding to the number of valve body assembly upper outlets; and
said valve member structured to move between a number of open positions wherein in each open position said valve member provides fluid communication between said valve body assembly inlet and a single valve body assembly upper outlet.

6. The refrigerant relief valve manifold of claim 5 wherein:
said valve body assembly base valve member chamber is a generally spherical chamber; and
said valve member is generally spherical.

7. The refrigerant relief valve manifold of claim 5 wherein:
said valve body assembly includes a plurality of upper branches;
each said upper branch defining a low pressure drop passage; and
each said upper branch passage in fluid communication with said valve member chamber and an associated valve body assembly upper outlet.

8. The refrigerant relief valve manifold of claim 7 wherein:
said valve body assembly plurality of upper branches includes a first branch and a second branch;
said valve body assembly first branch defining a low pressure drop first passage;
said valve body assembly second branch defining a low pressure drop second passage;
said valve body assembly number of upper outlets including a first upper outlet and a second upper outlet;
said valve body assembly first passage in fluid communication with said valve member chamber and said valve body assembly first upper outlet;
said valve body assembly second passage in fluid communication with said valve member chamber and said valve body assembly second upper outlet; and
said valve member movable between a first open position, wherein said valve member provides fluid communication between said valve body assembly inlet and said valve body assembly first outlet, and, a second position wherein said member provides fluid communication between said valve body assembly inlet and said valve body assembly second outlet.

9. The refrigerant relief valve manifold of claim 8 wherein:
said valve body assembly includes a unitary, substantially Y-shaped body and a lower coupling;
said valve body assembly Y-shaped body generally defining said valve member chamber; and
said lower coupling coupled to a valve body assembly Y-shaped body lower branch.

10. The refrigerant relief valve manifold of claim 8 wherein:
said valve body assembly includes a base element, lower coupling, a first branch member and a second branch member;
said valve body assembly base element including a body with a generally toroid, lower portion and an upper portion;
said valve body assembly base element body lower portion defining a lower, primary opening and generally defining said valve member chamber;
said valve body assembly base element body upper portion defining an angled, first opening and an angled, second opening;
said lower coupling coupled to said valve body assembly base element body lower portion primary opening;
said first branch member sealingly coupled to said valve body assembly base element body upper portion first opening; and
said second branch member sealingly coupled to said valve body assembly base element body upper portion second opening.

11. A refrigerant system comprising:
a number of conduits, each conduit defining a refrigerant fluid passage;
a refrigerant relief valve manifold sealingly coupled to one said conduit;
said refrigerant relief valve manifold including a valve body assembly and a valve member;
said valve body assembly defining a lower inlet and a plurality of upper outlets;
said valve body assembly defining a plurality of low pressure drop passages;
each valve body assembly low pressure drop passage extending between said lower inlet and an associated upper outlet;
said valve member movably disposed in said valve body assembly;
said valve member defining a plurality of low pressure drop passages;
said valve body assembly including a plurality of true mountings;
at least one valve body assembly true mounting defining at least one said upper outlet; and
each said valve body assembly true mounting structured to be coupled to a coupled element.

12. The refrigerant system of claim 11 wherein each low pressure drop passage is a vertical low pressure drop passage.

13. The refrigerant system of claim 11 wherein:
each said valve body assembly true mounting includes a collar; and
each said valve body assembly true mounting collar including internal threads.

14. The refrigerant system of claim 13 wherein:
each said valve body assembly true mounting collar includes an outer radial surface; and
wherein each said valve body assembly true mounting collar outer radial surface is non-circular.

15. The refrigerant system of claim 11 wherein:
said valve body assembly includes a base element;
said valve body assembly base element defining a valve member chamber;
said valve member movably disposed in said valve body assembly base valve member chamber;
said valve member including a single outlet and a number of inlets corresponding to the number of valve body assembly upper outlets; and
said valve member structured to move between a number of open positions wherein in each open position said valve member provides fluid communication between said valve body assembly inlet and a single valve body assembly upper outlet.

16. The refrigerant system of claim 15 wherein:
said valve body assembly base valve member chamber is a generally spherical chamber; and
said valve member is generally spherical.

17. The refrigerant system of claim 15 wherein:
said valve body assembly includes a plurality of upper branches;
each said upper branch defining a low pressure drop passage; and
each said upper branch passage in fluid communication with said valve member chamber and an associated valve body assembly upper outlet.

17. refrigerant system of claim 17 wherein:
said valve body assembly plurality of upper branches includes a first branch and a second branch;
said valve body assembly first branch defining a low pressure drop first passage;
said valve body assembly second branch defining a low pressure drop second passage;
said valve body assembly number of upper outlets including a first upper outlet and a second upper outlet;
said valve body assembly first passage in fluid communication with said valve member chamber and said valve body assembly first upper outlet;
said valve body assembly second passage in fluid communication with said valve member chamber and said valve body assembly second upper outlet; and
said valve member movable between a first open position, wherein said valve member provides fluid communication between said valve body assembly inlet and said valve body assembly first outlet, and, a second position wherein said member provides fluid communication between said valve body assembly inlet and said valve body assembly second outlet.

19. The refrigerant system of claim 18 wherein:
said valve body assembly includes a unitary, substantially Y-shaped body and a lower coupling;
said valve body assembly Y-shaped body generally defining said valve member chamber; and
said lower coupling coupled to a valve body assembly Y-shaped body lower branch.

20. The refrigerant system of claim 18 wherein:
said valve body assembly includes a base element, lower coupling, a first branch member and a second branch member:
said valve body assembly base element including a body with a generally toroid, lower portion and an upper portion;
said valve body assembly base element body lower portion defining a lower, primary opening and generally defining said valve member chamber;
said valve body assembly base element body upper portion defining an angled, first opening and an angled, second opening;
said lower coupling coupled to said valve body assembly base element body lower portion primary opening;
said first branch member sealingly coupled to said valve body assembly base element body upper portion first opening; and
said second branch member sealingly coupled to said valve body assembly base element body upper portion second opening.
